(19) United States
(12) Patent Application Publication
(10) Pub. No.: US 2004/0048228 A1
(43) Pub. Date: Mar. 11, 2004

(54) Disposable dental tray having interlocking handles

(75) Inventor: Herbert Wolfe, Edgewater, NJ (US)

Correspondence Address: STEINBERG & RASKIN, P.C., 1140 AVENUE OF THE AMERICAS, 15th FLOOR, NEW YORK, NY, 10036-5803, US

(73) Assignee: SULTAN DENTAL PRODUCTS, LTD.

(21) Appl. No.: 10/237,910

(22) Filed: Sep. 9, 2002

(51) Int. Cl. A61C 5/00; A61C 17/00

(52) U.S. Cl. 433/215; 433/80

(57) ABSTRACT

A disposable dental tray including a unitary member formed of a flexible foam material defining a pair of hinged U-shaped tray portions configured to fit over the upper and lower teeth of the mouth and wherein each tray portion is defined by a base wall, a pair of end walls and inner and outer side walls. A first one of the tray portions is provided with a handle that extends outwardly from the tray portion, the handle including a main portion and an end portion. The second one of the tray portions is provided with a handle that extends outwardly from the tray portion, the handle including a through slot adapted to receive and securely retain the end portion of the other handle.

### FIELD OF THE INVENTION

This invention relates generally to the application of dental medication to the teeth and, more particularly, to a disposable dental tray for use in the topical application of dental medications, such as fluoride gel or the like, to the teeth.

### BACKGROUND OF THE INVENTION

Periodic topical application of fluoride to the teeth is a common dental procedure. Such a treatment is generally performed in the dentist's office using a tray having tray portions formed therein having a configuration such that it will fit over the upper and lower teeth of the mouth. The tray is filed with the desired dosage of fluoride gel whereupon it is fit over the teeth to be treated.

Commonly the dental trays used in the above described procedure are constructed of a foam material enabling the dental tray to be easily disposed after use. Disposable dental trays formed of foam or the like and having a pair of hinged tray portions specifically designed to conform to the geometry of both the upper and lower teeth, respectively, are also known. The tray portions are hinged to each other by a pair of integral hinge portions with respect to which the tray can be folded until the tray portions which have been filled with fluoride obtain their in-use position. Disposable dental trays formed of a pair of hinged tray portions are sometimes provided with handles which extend outwardly from the tray portions to enable the dentist or dental technician to more easily place the tray into the patient's mouth. Known disposable dental trays formed of a pair of hinged tray portions and having a pair of handles are discussed in more detail below.

U.S. Pat. No. 4,173,219 to Lentine appears to disclose a foam dental tray having a pair of hinged tray portions specifically designed to conform to the geometry of both the upper and lower teeth. The dental tray further includes handles, each one of the handles extending from a respective one of the tray portions.

U.S. Pat. No. 4,428,373 to Seid et al. discloses a disposable dental tray having a pair of hinged U-shaped tray portions. Both of the tray portions are provided with positioning tabs, i.e. handles, extending from their respective outer side walls. The positioning tabs are preformed so as to be situated such that when the tray portions are folded, the respective tab sections will automatically abut and be squeezable against each other without the consequent application of any forces to the outer side walls of the tray portion thereby preventing any possibility of distorting the tray portions during use.

Some known disposable dental trays having handles are provided with means for selectively interlocking the handles to thereby maintain the tray in a folded state. Some known dental trays having such an arrangement are discussed below.

U.S. Pat. No. 5,211,559 to Hart et al. discloses a tray including a pair of hinged U-shaped tray portions. Extending from one of the tray portions is a handle provided with a transverse groove. Extending from the other one of the tray portions is a buckle including a tongue portion and a retainer strip surrounding the tongue portion so as to define a narrow space between the tongue portion and the retainer strip. When the tray is folded the handle is inserted into the narrow space and the tongue portion engages the transverse groove in the handle to thereby retain the handle in the buckle.

U.S. Design Pat. No. D456,515 appears to disclose a disposable dental tray having a pair of hinged U-shaped portions. Extending from one of the U-shaped portions is a narrow handle which includes a wider protuberance at the free end of the handle. Extending from the other one of the U-shaped portions is a wider handle that includes a recess at a free end of the handle, the recess being adapted to receive the other handle just above the protuberance.

Although the known dental tray having interlocking handles are useful they have some drawbacks in that it can be difficult to manually interlock one handle with the other. In addition some of the known dental trays have a rather complicated structure for interlocking the handles which adds to manufacturing costs and detracts from ease of use. Finally, in some of the known dental trays, during use, the handles can become separated after they have been interlocked which is clearly undesirable.

### OBJECTS AND SUMMARY OF THE INVENTION

Accordingly, one object of the present invention is to provide a new and improved disposable hinged dental tray for use in connection with the topical application of medication which avoids the drawbacks and shortcomings of known disposable dental trays.

It is another object of the present invention to provide a disposable dental tray that includes interlocking handles, the interlocking handles being structured and arranged so that once the handles are interlocked the handles reliably remain in the interlocked state.

It is a further object of the present invention to prove a disposable dental tray that is simple in construction, reliable and easy to use.

Briefly, in accordance with the present invention, these and other objects are obtained by providing a disposable dental tray including a unitary member formed of a flexible foam material defining a pair of U-shaped tray portions configured to fit over the upper and lower teeth, the tray further including a first and second handle, each one of the handles extending from a respective one of the tray portions. The first handle is provided with and end portion that is slightly wider than the remainder of the handle. The second handle is provided with a through slot that structured and arranged to receive the first handle. The width of the through slot is narrower than the width of the end portion of the first handle such that when the first handle is inserted through the through slot the first handle is securely retained within the slot and the two handles are securely interlocked.

### BRIEF DESCRIPTION OF THE DRAWINGS

A more complete appreciation of the present invention and many of the attendant advantages thereof will be readily understood by reference to the following detailed description when considered in connection with the accompanying drawings in which:

FIG. 1 is a perspective view of the disposable dental tray according to the present invention;

FIG. 2 is a section view of the dental tray according to the present invention taken along line 2-2 of FIG. 1; and

FIG. 3 is a side elevational view of the dental tray according to the present invention showing the handles in the interlocked state.

### DETAILED DESCRIPTION OF THE INVENTION

Referring now to the drawings wherein like reference characters designate identical or corresponding parts throughout the several views, a disposable dental tray 10 according to the present invention for the topical application of a medicament, such as fluoride gel, to the teeth is illustrated.

The tray 10 includes a unitary member 12 formed from a flexible foam material, preferably a closed cell polyethylene foam material, and defines a pair of troughs or tray portions 14a and 14b, each configured to fit over either one of the upper or lower teeth of the mouth. Thus, each tray portion 14 is formed by a base wall 16, a pair of end walls 18 and inner and outer side walls 20 and 22 respectively. Each of the pair of end walls 18 is associated with a particular one of the tray portions is in spaced opposed relationship to respective one of the pair of end walls 18 of the other tray portion as best seen in FIG. 2. A pair of hinge portions 24 integrally extend between respective pairs of opposed end walls 18 to interconnect the tray portions 14a and 14b. A fold line or fold slit 26 may be provided in each hinge to facilitate folding of the tray into its in-use position illustrated in FIG. 3.

According to the present invention, tray portion 14a is provided with a first handle 28 and tray portion 14b is provided with a second handle 30. Each of the handles 28 and 30 integrally extend outwardly from respective outer side walls 22 of the respective tray portion.

As shown, the first handle 28 is provided with a main portion 28a that extends from the tray portion and an end portion 28b. The end portion 28b has a width that is slightly wider than the width of the main portion 28a. Preferably, the end portion 28b has a substantially arrow type shape. That is, the end portion 28b preferably includes side walls 32 that extend outwardly slightly from the side wall 33 of the main portion 28a, the side walls 32 extending outwardly until they reach an apex 36 and then the side walls 32 tapering toward one other until they reach an apex 38 at the tip of the end portion 28b.

The second handle 30 has a width that is slightly greater than a width of the first handle 28. The second handle 30 is provided with a through slot 34 that extends through the body of the handle. The through slot 34 has a width a that is slightly wider than a width b of the main portion 28a of the first handle 28. The width a of the through slot 34 however is slightly narrower than a width c of the end portion 28b measured at the apexes 36. The configuration of the end portion 28b of the first handle 30 and the through slot 34 of the second handle 30 ensures that when the end portion 28b is inserted through the through slot 34 the first handle 28 is securely interlocked with the second handle 30. In addition the tapering of the side walls 32 from apexes 36 to apex 38 at the tip of the end portion 28a facilitates the insertion of the end portion 28a through the through slot 34. It is noted that the through slot 34 is entirely contained within the second handle 30. That is, the through slot 34 does not extend to the edge of the handle body. This configuration ensures that once the end portion 28a is inserted through the through slot 34 the handles are securely interlocked and the first handle 28 will not be unintentionally released.

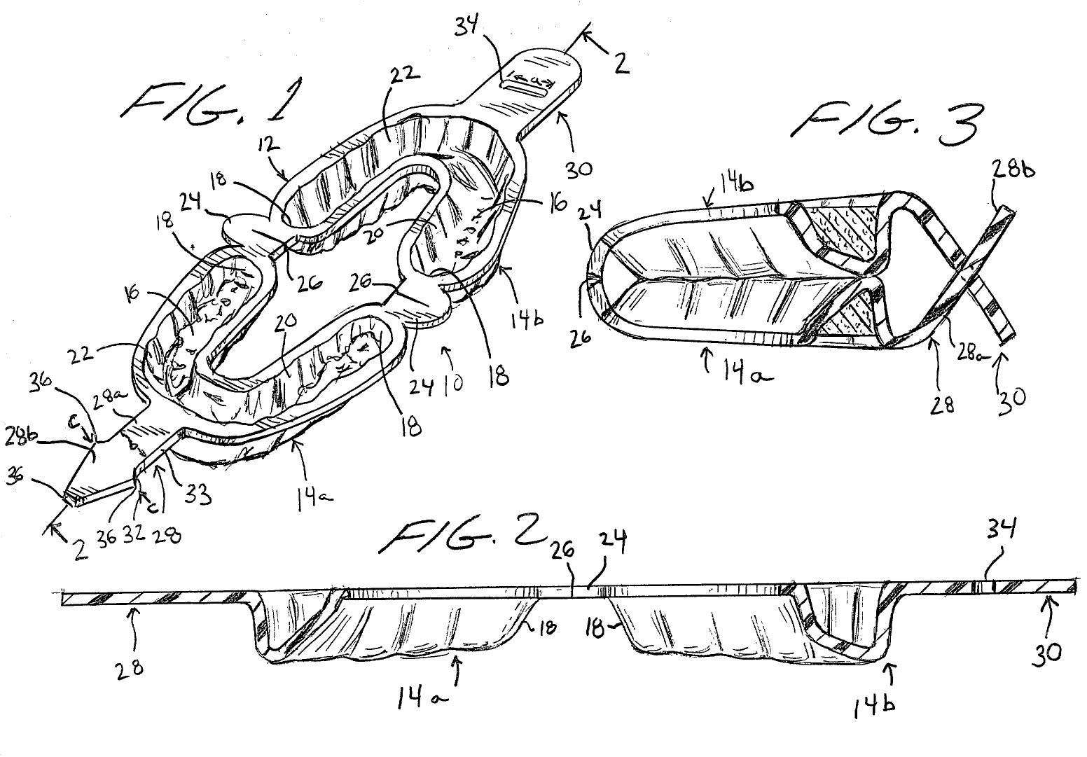

In use, the tray portions 14a and 14b are filled with fluoride gel or other medicament while in the configuration illustrated in FIGS. 1 and 2. The tray portions 14a and 14b are then folded on the hinge portions 24 toward the in-use position illustrated in FIG. 3. The end portion 28b of the first handle 28 is inserted through the through slot 34 in the second handle 30. The end portion 28b is inserted into the slot 34 until the apexes 36 of the end portion 28b pass thorough the slot. In this position, since the width c of the end portion 28b measured at the apexes 36 is wider than the width a of the through slot, the second handle 30 is securely retained in the slot 34 and the first and second handles, 28 and 30, are securely interlocked. According to the construction of the present invention, when the second handle 30 is interlocked with the first handle 28, the tray portions 14a and 14b will automatically be placed in the in-use position., i.e. the tray portions will be automatically placed in a position where the base wall 16 of the tray portions 14a and 14b are substantially contiguous.

Thus, the dental tray according to the present invention is simple in construction, easy to use, and the construction thereof permits the handles of the tray to be easily and securely interlocked. In this manner the dental tray according to the present invention overcomes the shortcomings of the prior art disposable dental trays.

Obviously, numerous modifications and variations of the present invention are possible in light of the above teachings. It is therefore to be understood that within the scope of the claims appended hereto, the invention may be practiced otherwise than as specifically disclosed herein.

I claim:

1. In a disposable dental tray for topical application of dental medication to the teeth including a unitary member formed of a flexible foam material defining a pair of U-shaped tray portions connected to each other by hinge means and configured to fit over the upper and lower teeth of the mouth when the tray portions are folded around the hinge means, and a first and second handle extending outwardly from a respective one of the tray portions, the improvement comprising:
said first handle having an end portion with a width greater than a width of a main portion of said first handle;
said second handle having a through slot, said through slot having a width that is less than the width of said end portion of said first handle and wider than the width of the main portion of said first handle;
whereby when said end portion of said first handle is inserted through the through slot in said second handle the first and second handles are securely interlocked to one another and the tray portions are automatically placed in the in-use position.

2. The combination of claim 1, wherein each tray portion is defined by a base wall, a pair of end walls and inner and outer side walls and wherein said first and second handles extend integrally and outwardly from said outer side walls of the respective tray portions.

3. The combination of claim 1, wherein said end portion has a substantially arrow type shape.

4. The combination of claim 1, wherein said end portion includes side walls that extend outwardly slightly from a respective side wall of the main portion, the side walls of the end portion extending outwardly until they each reach an apex along a respective side of the end portion and then the side walls tapering toward one other until they converge and define an apex at a tip of the end portion.

5. The combination of claim 4, wherein said width of said end portion is a width of said end portion measured across said end portion at said apexes.

6. The combination of claim 1, wherein said through slot is entirely contained within the body of the second handle.
